(19) United States
(12) Patent Application Publication
(10) Pub. No.: US 2007/0214263 A1
(43) Pub. Date: Sep. 13, 2007

(54) Online-Content-Filtering Method and Device

(76) Inventors: Thomas Fraisse, Montpellier (FR); Pierre Dutheil, Pignan (FR)

Correspondence Address: EGBERT LAW OFFICES, 412 MAIN STREET, 7TH FLOOR, HOUSTON, TX, 77002, US

(21) Appl. No.: 10/576,285

(22) PCT Filed: Oct. 18, 2004
(86) PCT No.: PCT/EP04/52571

§ 371 Date: Mar. 6, 2007

(30) Foreign Application Priority Data
Oct. 21, 2003 (FR) 03.12268

(51) Int. Cl. G06F 17/30

(52) U.S. Cl. 709/225

(57) ABSTRACT

The invention relates to an online-content-filtering method and device, including the use of a device, a case external to or a card internal to the computer, which is disposed between the computer and a computer network providing access to the online content. The device receives the content from the network. The method includes: a content analysis step; a step consisting of searching the environment of the content via the network; an environment analysis step; a filtering decision step which is performed as a function of a set of decision rules that is dependent on the results of the content and environment analysis steps; and a transmission step in which the content may or may not be transmitted to the computer depending on the result of the filtering decision step. Preferably, the pages to which the hypertext links of the content are directed are processed during the environment analysis step.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention concerns a process and device for on-line content filtering. It aims in particular to protect young Internet users from intentional or unintentional access to sites not intended for them (content of a sensitive nature: pornography, violence, incitement to racial hatred).

### BACKGROUND OF THE INVENTION

The existing filters which are generally based on the filtering of electronic addresses (Uniform Resource Locator “URL”), consist of software that compares a website address a user attempts to access with addresses contained in a data base. Such software can be deactivated like any other software and the extent of their filtering action is incomplete: their filtering rate reaches, on average, 90%, which is to say that one “forbidden” page out of ten reaches a young Internet user which poses a real problem in any school environment. Furthermore, the heuristics of data bases is faced with exponential growth of web pages published every month, whereas the number of websites indexed on a monthly basis grows in linear fashion. The consequence of this fact is that more and more websites slip past and are going to slip past the indexing of the solutions based on data bases. The filters bases on the analysis of “flesh” color also have their limits, and through excessive filtering bar access to any page containing the photo of a person, or example on medical information sites.

### BRIEF SUMMARY OF THE INVENTION

The present invention proposes to remedy these drawbacks.

For this purpose, the present invention consists, on the one hand, of providing an equipment, a separate box or a internal card inside the computer, that is inserted between the computer (the PC) and the Internet, and on the other hand, of this equipment actuating a set of rules for decisions that deal not only with the content of each website but also its environment (for example the websites that the links displayed on the requested website lead to, or the structural information, programmatic or statistical, of the requested website).

The filtering can also screen the content of a site as soon as it becomes accessible and thus of all websites accessible on line, independently from any URL data base.

From a first viewpoint, the present invention takes a sight on a filtering process for online content which is characterized by including:
actuation of an equipment, a separate box or a internal card inside the computer, that inserts itself between the computer and a computer network which provides access to online content, said equipment receiving the content coming from the network;
a step of analysis of said content;
a step of researching the environment of said content on said net;
a step of analysis of said environment;
a step of decision on filtering, based on a set of rules for decision depending on the results of the steps of analysis of said content and its environment; and
a step of transmission or not of said content to said computer, depending on the result of the filtering decision step.

Thanks to these provisions, the operation of the box performs a filtering not only based on the content which the user could access but also based on the environment of said content. Furthermore, since the filtering is done by an external box, it is harder to modify its operation than filtering software activated on the computer. Also, autonomous equipment can use its own resources (processing and/or memory) without consuming those of the computer.

According to particular characteristics, during the analysis step of said environment, the websites which the hypertext links of said content lead to are processed.

Thanks to these provisions, filtering is finer than when only the content of the website the user tries to access is processed.

According to particular characteristics, at least one step of analysis of said content includes a first step of rapid content screening, with the step of decision including a first step of making a decision depending on the result of said first step of rapid screening, and, in case of uncertainty of the result of said first step of decision-making, the step of analysis includes a second step of content screening of greater length than the first rapid screening step, the decision step then including a second step of decision-making, based on the result of the second screening step.

According to particular characteristics, the first step of rapid content screening processes a content that contains no images and the second step of content screening includes an image processing step.

Thanks to each of these provisions, the screening can be very fast for a large number of accessible web pages or contents, because as soon as one rule for decisions allows making a decision, it is taken. The screening is nevertheless very precise because a succession of rules for decisions is applied, for example thanks to image processing and to the comprehension of content of the images, for more complex cases.

According to particular characteristics, at least one step of analysis includes a step of image processing during which, for at least one image, the texture of the image content is analyzed in order to extract the parts of the image where the texture matches that of human flesh.

Thanks to these provisions the detection of flesh images is more certain than with a search for flesh color and the visible part of a human body represented by an image can be determined.

According to particular characteristics, the step of image processing includes a step of analyzing the posture of the person or persons whose body parts are visible.

Thanks to these provisions the analysis of the image content allows making an analysis and a more certain filtering decision.

According to particular characteristics, at least one step of analysis includes a step of character extraction from images incorporated into the online content.

Thanks to these provisions the textual messages present in the images can be processed to refine the semantic comprehension of the online content.

According to particular characteristics, the process as succinctly presented above includes a step of biometric identification of the user and a step of deactivating the filtering and of authorizing access to all accessible content on the computer network, based on the result of said identification.

Thanks to these provisions, an authorized user, such as an adult, can access all accessible content online and identification of this user is more certain than with a password and less constraining for the user.

According to particular characteristics, the process as succinctly presented above includes a step of transmission to a remote computer system connected to said computer network of an information set including a command, a user identifier and a box identifier and a verification step by the remote computer system of the rights associated to said identifiers and a box command step, by the remote computer system to deactivate the filtering and to authorize access to all content accessible on the computer network.

Thanks to these provisions, the operation of the box is more certain than if the deactivation decision were made solely by the box which could then be overridden locally.

According to particular characteristics, the process as succinctly presented above includes, when the equipment has been deactivated, an equipment activation step for the next time the computer is restarted or for the next start of a session with said computer.

From a second viewpoint, the present invention takes a sight on equipment, external box or an internal card inside the computer for online content filtering which is inserted between the computer and a computer network which gives access to online content, said equipment receiving the content from the network, characterized by the fact that it includes:
a means for analyzing said content;
a means of researching the environment of said content on said network;
a means of analyzing said environment;
a means of decision-making for filtering, based on a set of rules for decision-making depending on the results of the steps of analysis of said content and its environment; and
a means of transmitting or not said content to said computer, depending on the result of the step of decision-making for filtering.

As the advantages, goals and particular characteristics of this second aspect are identical to those of the process succinctly presented above, they are not repeated here.

### BRIEF DESCRIPTION OF THE SEVERAL VIEWS OF THE DRAWINGS

Other advantages, goals and characteristics of the present invention will become apparent from the description which follows, and which is made for the purpose of explaining and in no way limiting with respect to the attached drawings.

FIG. 1 shows a schematic view of the positioning of a box in accordance with the present invention, in a computer system connected to a computer network.

FIG. 2 shows a schematic view of the functional modules of a particular way of carrying out the box shown in FIG. 1.

FIG. 3 shows a schematic view of a logical diagram of steps implemented in a particular way of carrying out the process which is the subject of the present invention.

### DETAILED DESCRIPTION OF THE INVENTION

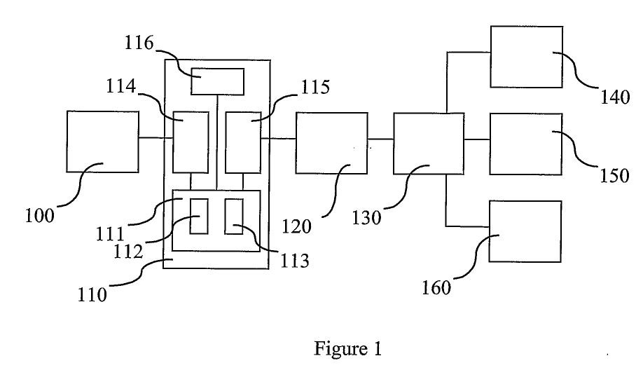

One can observe in FIG. 1, a personal computer (PC) 100, connected to a box 110 which is itself connected to a modulator-demodulator (modem) 120 connected to a computer network 130 which in turn is connected to remote servers 140, 150, and 160. The connections shown may be hardwired or wireless, depending on the known communication techniques.

The personal computer (PC) 100 represents a computer system which may include a personal computer of the known type or a local network of several computers of the known type. During the installation of the computer application which in a personal computer 100 manages the communication with the box 110, a box driver is installed so that the personal computer cannot access the computer network 130 without going through the intermediary of box 110. Operation of the box can therefore not be deactivated like any software; it is integrated into the operation of the computer 100 through a secured link that is constantly checked.

The box 110, subject of the present invention includes a printed circuit board 111 with a microprocessor 112 and with a non-volatile memory 113 and interfaces 114 and 115 which permit the box to communicate on the one hand with the personal computer (PC) 100 and on the other hand with the modem 120 and through the intermediary of this modem 120 and the computer network 130, with the servers 140, 150, and 160.

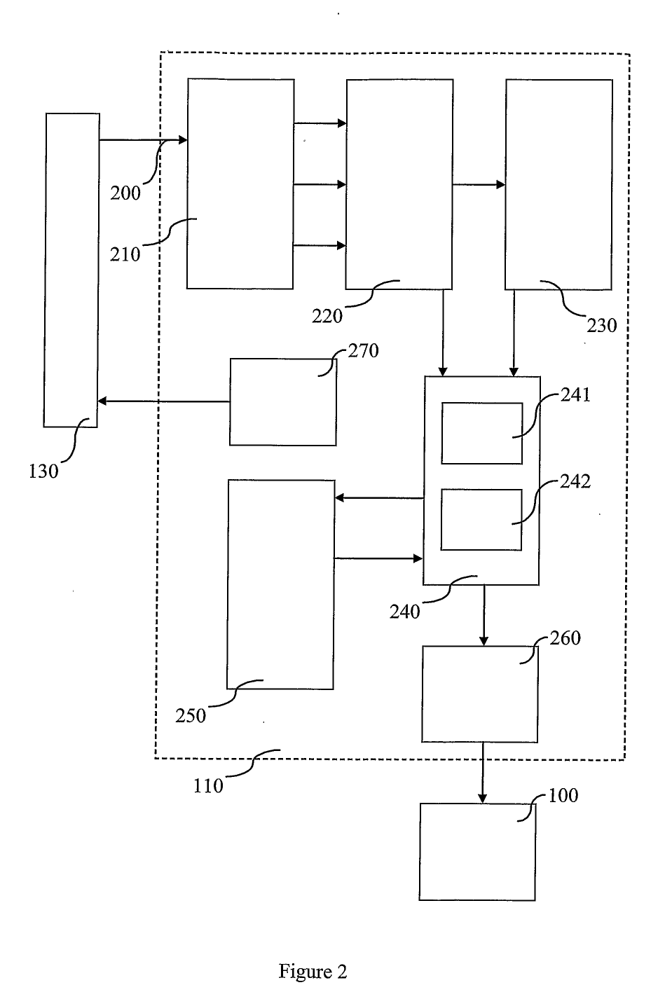

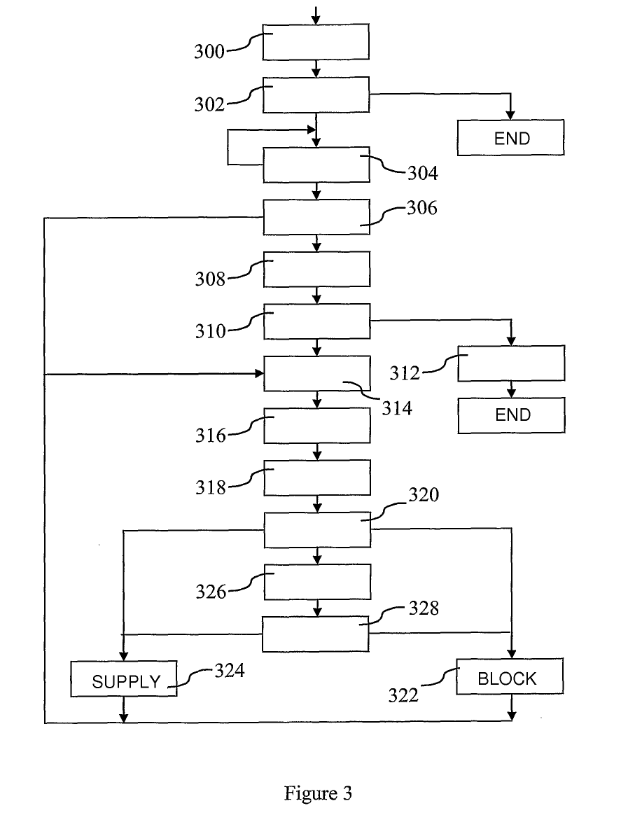

The non-volatile memory 113 stores program instructions that are intended to be executed by the microprocessor 112 in order to implement the process that is the subject of the present invention and, for example, the functions shown in FIG. 2 and/or the logical diagram shown in FIG. 3.

In the way of carrying out the invention described in FIG. 1, the box 110 includes a means of identification with a hardware key 116, for example with a chip card or with biometric measuring, for example a fingerprint reader.

The modem 120 is of the know type, for example for communication on a switched network, possibly with a high speed connection. The computer network 130 is for instance the Internet. The remote servers 140, 150, and 160 are of the known type. In the way of carrying out the invention shown here the server 140 is dedicated to the control, to electronic intelligence and the command of boxes identical to box 110. In other ways of carrying out the invention the box 110 does not operate under the control of a remote server.

Server 140 stores all or part of the data bases activated by the boxes 110, for instance word dictionaries and each box 110 updates its data bases by referencing the data bases stored by server 140.

Servers 150 and 160 store informational content. For instance, server 150 is a server hosting a commercial site for the sale of household appliances, an information site for patents and a medical site dealing with pathologies of the human body and server 160 is a server hosting a site for adults including content, in particular images and films including images of a pornographic nature.

As a variant, box 110 is replaced by an internal card in the personal computer 100 and functions as described above. In the following description the term “box” covers both the case of a box that is external to the personal computer 100 and also the case of an electronic card that is internal to the personal computer 100.

One observes that the box 110 can as a variant be placed between the modem 120 and the computer network 130. In this case it includes itself a modem to communicate on the computer network 130.

The box 110 contains various modules which interact with each other to create an efficient filtering system for data entering the computer and perhaps a firewall, an anti-virus module, a pop-up window blocker module, these modules using the calculation and memory resources of box 110 without consuming the resources of the personal computer 100 and thus prevent the viruses from reaching the personal computer 100.

To install box 110 in one of the configurations shown in FIG. 1, one proceeds as follows:
connect the box between the modem and the computer;
identify or authenticate, by the identifying hardware key 116 of box 110, the person who will be authorized to deactivate or to remove the box, either by insertion of a hardware key, or by recognition of a biometric measurement, for example by the fingerprint reader;
carry out the installation, for example by accessing server 140, or by inserting a compact disc (CD-ROM) in the CD-ROM player of computer 100 and start the installation; during installation the authorized user indicates whether (s)he wants to receive an email every time the box 110 is deactivated and, if yes, at which email address (s)he wants to receive the appropriate emails;
box 110 then identifies the computer 100, i.e., determines of it a sufficiently unique profile to recognize the computer 100 as it will be used later on, connects itself to the remote server 140 and provides it with an identifier (for example a serial number which it stores in a non-volatile memory);
the server 140 then verifies the proper functioning of box 110, verifies the validity of the subscription of the user of said box and initializes the box. The user then inputs his personal identification code or inputs the fingerprint of the designated user, i.e., an adult who authenticates the designated user (serves also as identification for access to online data concerning the operation of the box and the subscription to the protection services it provides);
a supplementary step is added to the startup procedure of the computer 100: verification of the box 110 without which access to the Internet is not authorized, therefore impossible; and
filtering is then activated by default at every restart of the computer 100 or at each opening of a computer session, with the deactivation of box 110 or the change of its parameters requiring identification of the authorized person by the hardware key identification device 116.

For the continuation of the operation the personal computer 100 and the box 110 perform a verification of the presence of the box 110 and of the personal computer 100 respectively, and in case an absence is detected, they send an “absence detected” signal to the remote server 140 and an email to the user identified by box 110, then terminate the connection to the computer network 130 and block the possibility of connecting to the computer network 130.

After authentication of the user's identity, it is possible to deactivate, uninstall or modify the filtering parameters of box 110:
prohibit downloading of certain types of files (“mpeg”, “.avi”, “.zip” . . . ),
block peer-to-peer sites,
block online chats or, at least the transfer of documents on these chats unless the chat implements identifications by email address and if the correspondent's address matches an address present in an email address book referenced as “reliable” by the authorized user of box 110,
block NNTP (newsgroup or discussion group) and/or
not analyze incoming emails from addresses considered to be reliable in the address book linked to the filtering functions.

Each deactivation of the box causes the transmission to server 140 of a log entry so that server 140 keeps a record of this deactivation which the user can view after having been identified by the hardware key identification device 116.

FIG. 2 shows an input 200 of information coming from network 130, an acquisition and screening module of information type 210, a contextual processing module 220, a semantic and textual processing module 230, a decision module 240 including a first decision module 241 and a second decision module 242, an image analysis module 250, an output of information 260 intended for the computer 100 and an information transmission module 270 on the network 130.

The input 200 receives all information coming from the network 130 intended for the computer 100, in the form of a frame in conformance with the IP (Internet Protocol). The acquisition and screening module of information type 210 receives this information and sorts it according to its type:
information coming from a website,
information coming from a chat site, and
information arriving via email,
   depending on the protocol according to which this information is transmitted (the HTTP, NNTP, SMTP or other protocols respectively).

Generally and preferably the box 110 performs the filtering of data by first carrying out the analyses which can be very fast (analysis of key words and tags for instance) and if it is able to conclude from this first analysis that the information must not be sent to the PC user, it does not send it and in the opposite case, it performs a second analysis which takes longer to process (processing of pages linked to the analyzed page, of criteria on the page, see below, of javascripts, . . . ) and if it is able to conclude from this second analysis that the information must not be sent to the PC user, it does not send it, and in the opposite case, it performs a third analysis (for instance processing of images on the page shown below) and so on until all processing has been done and until the last decision to transmit or not transmit the page, has been made.

For the sake of simplification only two steps and processing means, followed by two steps and decision-making means are described below.

The contextual processing module 220 determines and processes the following information:

a) If it is information coming from a website (HTTP protocol) the contextual processing module 220 analyzes the content of the page received;
it determines the language of the page, compares the keywords contained in the electronic address (URL) of the page, in the “keyword” and “description” metatags and in the source key of the page to a dictionary of the most current forbidden words (dictionary stored in the non-volatile memory of box 110);
it researches specific markers of self-declaration of content of the page (for example PICS, ICRA markers . . . );
if the requested page has an electronic address (URL) which does not correspond to the home page of the website, it researches this home page on the network 130 (by shortening the electronic address URL by leaving off its last characters, perhaps in several stages, and depending on the characters “/”) and, on this home page, a “disclaimer” in case of a sensitive character of the page susceptible to shock which asks for voluntary acceptance (by clicking the “Enter” key);
it performs a summary of the different criteria of the page: number of works, hypertext links, images, scripts, file sizes, file formats, scripts, text content and semantic vectors (grouping of words having special meaning) . . .
it analyzes javascripts (their presence and their action, for instance page opening or pop-up and analysis of pop-up); and
it researches, downloads and analyzes the pages that are accessible through the links present on the analyzed page as indicated above.

In a preferential mode of carrying out the invention, the contextual processing module 220 performs a gathering of the texts on the page during which, if texts are embedded in computer art or images, these texts are extracted from them and added to the page information received in text format, to texts of the electronic address (URL) of the page et the “keyword” and “description” metatags. For example, an optical character recognition is done to extract the texts from images and computer art.

b) if the information is of email (SMTP protocol) type, the philosophy of email filtering is based on the comfort of the user who will not be bothered by unwanted email (advertising, spam, automatic mailing lists, content of attachments). If the incoming email comes from a reliable email address present in the address book linked to the filtering functions, in the box memory, the mail is not analyzed. If the incoming email does not come from a sender registered in the address book, the contextual processing module 220:
determines whether there is at least one image or a file likely to contain one in the body of the email or in the attached files;
reads and analyzes the links contained in the emails (and analysis of the metatags of the linked page) as indicated above; and
performs a textual analysis of the content of the mail as indicated above.

In a preferential mode of carrying out the invention, the contextual processing module 220 performs a multilingual linguistic simplification during which the language of the textual information is first determined in the known manner, then each word of the text is put in association with a synonym in the same language, synonym which can be the original word itself or with a word of the same language considered to have approximately the same meaning, by implementing a table of correspondences or a dictionary of synonyms or of words having approximately the same meaning.

c) for information coming from chat or newsgroups (NNTP protocol), the contextual processing module 220 determines whether the information coming from third parties is coming from users referenced by the authorized user of box 110 as being reliable, in the email address book.

The results of the processing performed by the contextual processing module 220 are simultaneously sent to the semantic and textual processing module 230 and to the first decision module 241.

In a preferential way of carrying out the invention, the semantic and textual processing module determines the type of semantic content of the page by means of a morpho-syntactic analysis of the text, by using conceptual vectors (thesaurus and/or dictionary). The results of the processing performed by the semantic and textual processing module 230 are sent to the first decision module 241.

Then the processing module 230 performs an extraction of criteria by vectorization of the page, and classification according to classifiers that are specialized by categories or domains. To this effect the processing module 230 counts predefined elements, images, words after their linguistic simplification, for example.

The first decision module 241 makes a first determination of a decision to send or not to send the content of the page to the computer 100, depending on the results coming at least from module 220 and possibly from module 230. When one of the processing [operations] performed by one of these modules 220 and 230 provides, through processing by logical rules (“expert” rules), a result that can be interpreted immediately to block the transmission of the content, for example the presence of advertising, the first decision is to block the content.

Failing this, the first filtering decision is taken by a neural network or in fuzzy logic, in accordance with the known techniques.

In a preferential way of carrying out the invention, in the semantic and textual processing module 230, a secondary classifier processes the results for each screening criterion (number of images, number of predefined words, for instance) and provides a classification or grade result and a classifier processes the results of the secondary classifiers, possibly by weighting them, in order to determine whether the page may be transmitted to the user.

The result of the first decision may be:
decision to block the content,
decision to forward the content to the computer 100, and
decision to continue analyzing the content.

In the third case, the information to be processed is transmitted to the image analyzing module 250 which performs the following processing operations:
extraction of characters and recognition of words in the image files (for instance buttons, images and computer art) present on the page, for example with optical character recognition;
transmission of these words to the contextual processing module 220 and to the semantic processing module 230 for the processing [operations] listed below to be carried out;
search for flesh texture (identified by the presence of few contours in a color corresponding to flesh and by a low, but not entirely absent, density of contour points on the flesh colored part) in the images, determination of the number of images containing any of this;
plotting of contours of areas featuring flesh texture, recognition of shapes, search for eyes, mouth, hands in the image to determine the posture of the different subjects, number of subjects in the image, close-ups (these steps can be performed by a neural network);
in the case of emails, newsgroups and chats, analysis of attached image files; and
analysis of other elements of the environment of the page (banners, pop-up windows) as indicated above.

Depending on the results of these processing operations, the second decision module 242 makes a final decision, by activating a neural or fuzzy logic network:
decision to block the content based on the parameters that have been personalized by the user; or
decision to forward the content to computer 100.

One observes that the second decision module 242 can for example implement a Bayes classifier and a decision tree (this method being considered to be reliable, proven and fast).

As a variant, the second decision module performs the same processing as the module of first decision, but they are applied to the environment of the page, for example other pages that the links provided on the web page lead to and the final decision for transmission to the user is taken whereupon the modules 220 and 230 are implemented.

The information output 260 with the computer 100 as its destination permits, when the image is not filtered or blocked, to send the content of the requested page to the computer 100.

When the designated user wants to stop the operation of the box 110, the network information transmission module 270 sends to the server 140 a triplet of information including the user's command, his identifier and that of the box 110. The remote server 140 verifies the authorizations and the sent information and possibly commands the box 110 to grant access to all content accessible on the network 130.

Below is a review of the fuzzy approach of the analysis or of the classification.

The fuzzy models or Fuzzy Inference Systems (FIS) make it possible to represent the behavior of complex systems. The theory of fuzzy sets permits a simple representation of uncertainties and inaccuracies linked to information and knowledge. Its main advantage is to introduce the concept of gradual appurtenance to a set whereas in classic ensemble logic this appurtenance is binary belongs or does not belong to a set [or ensemble]. An element can thus belong to several sets with degrees of appurtenance of 0.15 and 0.6 for example.

FIG. 3 shows a succession of steps taken in a particular way of carrying out the process which is the subject of the present invention.

Following the initialization step 300 of the computer 100 and the box 110, during a step 302 the computer 100 determines whether the box 110 is properly connected to it. If not, the computer 100 prohibits any connection to the computer network 130 and the operating process in accordance with the procedure which is the subject of the present invention has been achieved. Thus, at each startup of the computer and each time a session on this computer is opened, the equipment for filtering the content that is accessible online is activated.

If the box 110 is properly connected to the computer, one determines during a step 304 whether the user attempts to access an online content. If not, one returns to step 304. If yes, the box, during a step 306 authorizes the connection to the network 140 and determines whether the user has entered a command of deactivation. If not, one goes to step 314. If yes, during a step 308 the designated user's identity is verified, for instance by identifying a hardware key (for instance a memory card or a fingerprint) et a triplet of information, including the user's command, his identifier and that of the box 110, is sent to the remote server 140. The remote server 140 verifies the authorizations and information that were sent, step 310, and if the designated user is authenticated, it orders the box 110 to grant access to all content accessible on the network 130, step 312 and the operating process in accordance with the procedure which is the subject of the present invention has been achieved.

During step 314 the information coming from the computer network 130 is sorted according to its type:
information coming from a website,
information coming from a chat site, and
information coming via email,
   depending on the protocol according to which this information is transmitted (HTTP, NNTP and SMTP respectively).

During a step 316 the following information is determined and processed:

a) If this is information coming from a website (HTTP protocol) the content of the page received is analyzed;
the language of the website is determined, the keywords contained in the URL address of the site, in the “keyword” and “description” metatags and in the source code of the site are compared to a dictionary of the most current forbidden words (dictionary stored in the non-volatile memory of the box 110);
specific markers of self-declaration of content of the website are researched (for example PICS, ICRA . . . markers);
if the requested page has an electronic address (URL) which does not correspond to the home page of the website, this home page is researched on the network 130 (by shortening the electronic address URL by leaving off its last characters, perhaps in several stages, and depending on the characters “/”) and, on this home page, a “disclaimer” in case of a sensitive character of the page susceptible to shock which asks for voluntary acceptance (by clicking the “Enter” key);
a summary of the different criteria of the page is performed: number of works, of hypertext links, of images, scripts, file sizes, file formats, scripts, text content and semantic vectors (grouping of words having special meaning) . . .
javascripts are analyzed (their presence and their action, for instance, page opening or pop-up and analysis of pop-up);
the pages that are accessible through the links present on the analyzed page are researched, downloaded and analyzed as indicated above;
if the information is of email (SMTP protocol) type, the philosophy of email filtering is based on the comfort of the user who will not be bothered by unwanted email (advertising, spam, automatic mailing lists, content of attachments). If the incoming email comes from a reliable email address present in the address book linked to the filtering functions, in the box memory, the mail is not analyzed. If the incoming email does not come from a sender registered in the address book:
it is determined whether there is at least one image or a file likely to contain one in the body of the email or in the attached files;
the links contained in the emails (and analysis of the metatags of the linked page) are read and analyzed as indicated above;
a textual analysis of the content of the mail is performed as indicated above.

b) if the information is of email (SMTP protocol) type, the philosophy of email filtering is based on the comfort of the user who will not be bothered by unwanted email (advertising, spam, automatic mailing lists, content of attachments). If the incoming email comes from a reliable email address present in the address book linked to the filtering functions, in the box memory, the mail is not analyzed. If the incoming email does not come from a sender registered in the address book:
It is determined whether there is at least one image or a file likely to contain one in the body of the email or in the attached files;
the links contained in the emails (and analysis of the metatags of the linked page) are read and analyzed as indicated above;
a textual analysis of the content of the mail is performed as indicated above.

In a preferential mode of carrying out the invention, during step 316, a gathering of the texts on the page is performed during which, if texts are embedded in computer art or images, these texts are extracted from them and added to the page information received in text format. For example optical character recognition is performed to extract the texts from images and computer art.

In case of filtering the user of the personal computer is notified, by opening of a dialog box and the files are not destroyed.

c) for information coming from chat or newsgroups (NNTP protocol), it is determined whether the information coming from third parties is coming from users referenced by the authorized user of box 110 as being reliable, in the email address book.

Then, during a step 318, the type of semantic content of the page is determined by means of a morpho-syntactic analysis of the text, by using conceptual vectors (thesaurus and/or dictionary).

In a preferential mode of carrying out the invention, during step 318 a multilingual linguistic simplification is performed during which the language of the textual information is first determined in the known manner, then each word of the text is put in association with a synonym in the same language, synonym which can be the original word itself or with a word of the same language considered to have approximately the same meaning, by implementing a table of correspondences or a dictionary of synonyms or of words having approximately the same meaning.

In this preferential mode of carrying out the invention, during step 318, an extraction of criteria is performed by vectorization of the page, and classification according to classifiers that are specialized by categories or domains. To this effect the processing module 230 counts predefined elements, images, words after their linguistic simplification, for example.

During a step 320 of determining the first decision, a first determination of the decision to transmit or not to transmit the content of the page to the computer 100, depending on the results coming from steps 316 and 318.

When one of the processing operations performed by one of these modules delivers, by a processing according to logical rules, an immediately interpretable result to block the transmission of the content, for example the presence of advertising, during step 320, it is determined that the first decision is to block the content. In a preferential way of carrying out the invention, during step 320 a secondary classifier processes the results for each screening criterion (number of images, number of predefined words, for instance) and provides a result of classification or grade and a classifier processes the results of the secondary classifiers by possibly weighting them, in order to determine whether the page can be delivered to the user.

Failing this, the first decision for filtering is made by a neural network or in fuzzy logic, in accordance with the known techniques. The result of this first decision may be:
decision to block the content (the content is not delivered to the computer and an “Access denied” message is displayed, step 322);
decision to forward the content to the computer 100 (the content is delivered to the computer 100 as if the box 110 were not associated with the computer step 324) or
decision to continue analyzing

In the third case, during a step 326, the following processing operations are performed:
extraction of characters and recognition of words in the image files (for example advertising buttons, images and computer art) present on the web page, for example with optical character recognition;
contextual processing as indicated in step 316 and semantic processing as indicated in step 318;
search for flesh texture (identified by the presence of few contours in a color corresponding to flesh and by a low, but not entirely absent, density of contour points on the flesh colored part) in the images, determination of the number of images containing any of this;
plotting of contours of areas featuring flesh texture, recognition of shapes, search for eyes, mouth, hands in the image to determine the posture of the different subjects, number of subjects in the image, close-ups (these steps can be performed by a neural network);
in the case of emails, newsgroups and chats, analysis of attached image file; and
analysis of other elements of the environment of the page (banners, pop-up windows) as indicated above.

Depending on the results of these processing operations during a step 328 of the second decision a final decision is made, by activating a neural or fuzzy logic network:
decision to block the content, step 322, based on the parameters that have been personalized by the user, or
decision to forward the content to computer 100, step 324.

Following one of the steps 322 or 324, one returns to step 314.

As a variant, the step 328 performs the same processing operations as those applied for the first decision, but applied to the page environment, for instance other pages the links provided on the web page lead to and the final decision for transmission to the user is taken whereupon the modules 220 and 230 are implemented.

As a variant, the validation step of the user's command is performed as soon as the user has been authenticated, by password or biometric measurement, for instance, without having recourse to the remote server 140.

As a variant, step 318 is omitted.

One observes that the second decision step 328, can for example implement a Bayes classifier and a decision tree (this method being considered to be reliable, proven and fast).

Preferentially, the classification is done after an apprenticeship “in a lab” of page categories, in accordance with techniques known in the domain of web mining or content mining. To this effect, the classifier is given large quantities of pages of every category to learn and it then automatically recognizes to which category a newly submitted page belongs

I claim:

1. Filtering process for online content, said filtering process comprising the steps of:
implementing an equipment, external box or internal computer card, inserted between a computer and a computer network providing access to online content, said equipment receiving content from the internet;
analyzing said online content;
researching environment of said online content on said internet;
analyzing said environment;
deciding to filter depending on a set of rules for decision-making depending on results of the steps of analyzing said online content and researching environment; and
transmitting or not of said online content to said computer, depending on a result of the step of deciding to filter.

2. Process as per claim 1, wherein, during the step of analyzing said environment, pages reached through hypertext links of said online content are processed.

3. Process as per claim 1, wherein the step of analyzing said online content comprises:
a first step of rapid content screening, with a step of deciding being comprised of a first step of determining a decision depending on a result of said first rapid content screening step, in case of non-determination of the result of said first step of determining a decision; and
a second step of screening content of greater length than a first rapid screening step, with the step of decision then comprising a second step of determinating a decision depending on a result of the second screening step.

4. Process as per claim 3, wherein the first step of rapid content screening processes a content containing no images and wherein the second step of screening content is comprised of image processing.

5. Process as per claim 1, wherein at least one step of analyzing comprises:
a step of image processing during which, for at least one image, texture of image content is analyzed in order to extract the parts of the image where texture matches that of human flesh.

6. Process as per claim 5, wherein the image processing step is comprised of a step of analyzing a person or persons whose bodies are partly exposed.

7. Process as per claim 1, wherein at least one step of analyzing is comprised of a step of extracting characters from images incorporated in the online content.

8. Process as per claim 1, further comprising:
a step of identifying a user, and
a step of deactivating filtering and authorization for access to all content accessible on the computer network depending on the result of identification.

9. Process as per claim 1, further comprising:
a step of transmission to a remote computer system linked to said computer network, of a set of information being comprised of a command, a user identifier and an equipment identifier; and
a step of verification by the remote computer system of the rights associated with said identifiers and a step of command to the equipment from a remote computer system to deactivate filtering and to authorize access to all content accessible on the computer network.

10. Process as per claim 8, wherein, when the equipment is deactivated, a step of activation of the equipment at the next startup of the computer or at the next opening of a session with said computer.

11. Equipment, external box or a card inside a computer for filtering online content, which inserts between the computer and a computer network, giving access to online content, said equipment receiving the content coming from the network, the equipment comprising:
a means for analyzing said content;
a means for researching of environment of said content on said network;
a means for analyzing said environment;
a means for deciding to filter depending on a set of rules for decision-making, depending on results of analysis of said online content and said environment; and
a means for transmitting or not said online content to said computer, depending on a result of the step of deciding to filter.

12. Equipment as per claim 11, wherein said means for analyzing of said environment processes pages that are reached through hypertext links of said online content.

13. Equipment as per claim 11, wherein at least one means for analyzing said content has been adapted to perform a first rapid content screening, the means for decision being adapted to perform a first determination of decision depending on the result of said first rapid screening and, in case of non-determination of the result of said first step of determination of a decision, the means for analyzing has been adapted to perform a second content screening of longer duration that the first rapid screening, the means of decision-making then performing a second determination of decision depending on the result of the second screening.

14. Equipment as per claim 13, wherein said first rapid content screening processes content that does not contain any images and that the second content screening does include image processing.

15. Equipment as per claim 11, wherein at least one means for analyzing comprises a means for image processing that has been adapted, for at least one image, to analyze the texture of the content of the image in order to extract those portions of the image where the texture matches that of human flesh.

16. Equipment as per claim 15, wherein said image processing includes an analysis of posture of a person or persons whose parts of bodies thereof are visible.

17. Equipment as per claim 11, wherein at least on means for analyzing has been adapted for extracting characters from images incorporated into the online content.

18. Equipment as per claim 11, wherein a means for identification of the user by hardware key, the means for decision-making as being adapted, depending on the result of the identification, to deactivate the filtering and to authorize access to all content accessible on the computer network.

19. Equipment as per claim 1, wherein said means for transmitting to a remote computer system connected to said computer network, a set of information including a command, a user identifier and an equipment identifier and a means for receiving, from the remote computer system, a command to the equipment to deactivate the filtering and to grant access to all content accessible on the computer network.

20. Equipment as per either of claims claim 18, comprising a means of activation B that is capable, when equipment has been deactivated, to activate the equipment at the next startup of the computer or at the next opening of a session with said computer.
